(19) United States
(12) Patent Application Publication
(10) Pub. No.: US 2015/0117705 A1
(43) Pub. Date: Apr. 30, 2015

(54) Hybrid Parking Detection

(71) Applicant: ChengDu HaiCun IP Technology LLC, ChengDu (CN)

(72) Inventors: Guobiao ZHANG, Corvallis, OR (US); Yaofei FENG, Corvallis, OR (US); Bruce Bing WANG, ShangHai (CN)

(73) Assignee: ChengDu HaiCun IP Technology LLC, ChengDu (CN)

(21) Appl. No.: 14/147,586

(22) Filed: Jan. 5, 2014

Related U.S. Application Data
(60) Provisional application No. 61/895,983, filed on Oct. 25, 2013.

(51) Int. Cl. G06K 9/00; G06T 7/00; G08G 1/14

(52) U.S. Cl. CPC G06K 9/00812; G08G 1/141; G06T 7/0085; G06T 2207/10004; G06T 2207/20144; G06T 2207/30264; G06T 2207/20148
USPC 382/103

(57) ABSTRACT

The present invention combines the strengths of the background-subtraction and edge-detection algorithm for parking detection. Being computationally efficient, the background-subtraction algorithm is used whenever possible. On the other hand, being robust, the edge-detection algorithm is used at calibration points, or when the background-subtraction algorithm cannot reliably determine the parking state.

### CROSS-REFERENCE TO RELATED APPLICATIONS

This application claims priority of a provisional application entitled “Hybrid Parking Detection”, Ser. No. 61/895,983, filed Oct. 25, 2013.

### BACKGROUND

1. Technical Field of the Invention

The present invention relates to the field of electronics, and more particularly to device and method to detect parked vehicles.

2. Prior Arts

Locating a vacant parking space causes much frustration to motorists. It increases fuel consumption and has a negative impact to the environment. To conserve energy resources and enhance the quality of the environment, it is highly desired to develop a parking-monitoring system, which can transmit substantially real-time parking states (i.e. occupied or vacant) to motorists. Based on the parking states, a motorist can be guided towards a vacant parking space at destination.

Parking enforcement is an important aspect of city management. The current parking-enforcement system is patrol-based, i.e. parking enforcement officers patrol the streets and/or parking lots to enforce the parking regulations. This operation requires significant amount of man power and also consumes a lot of fuel. It is highly desired to take advantage of the above-mentioned parking-monitoring system and automatically measure the parking time for each monitored parking space.

Both parking monitoring and enforcement are based on the detection of parked vehicles (i.e. parking detection). The parking-detection methods disclosed in prior arts can be categorized into background-subtraction algorithm and edge-detection algorithm. For the background-subtraction algorithm, a parking space is detected as occupied if there is substantial difference between a current image and a background image (i.e. the image of the parking space when it is vacant) within the region of interest (ROI). For each parking space, its ROI is a region in its image that is processed for parking detection. For the edge-detection algorithm, a parking space is detected as occupied if at least a detected edge within its ROI is substantially parallel to its exposed edge. The exposed edge of a parking space is an edge that is not occluded by any parked vehicles. Note that the ROI for the background-subtraction algorithm might be different from the ROI for the edge-detection algorithm.

FIGS. 1A-1B disclose more details about the background-subtraction algorithm. The parking area along a curb 10 includes three parking spaces A1-C1. In FIG. 1A, the parking spaces A1, C1 are occupied by two vehicles 30a, 30c, respectively, while the parking space B1 is vacant. The ROI 60b for the parking space B1 is located inside the parking space B1. In FIG. 1B, the parking space B1 is occupied by the vehicle 30b and a major portion of the ROI 60b shows the image of the parked vehicle 30b. Because there is a substantial difference between the current image and the background image, the parking space B1 is detected as occupied.

FIGS. 2A-2B disclose more details about the edge-detection algorithm. In FIG. 2A, the ROI 70b (for the edge-detection algorithm) is different from the ROI 60b (for the background-subtraction algorithm) of FIG. 1A. It is not located inside the parking space B1, but formed by scanning at least a portion of the exposed edge 16 of the parking space B1 upward. In FIG. 2B, the parking space B1 is occupied by the vehicle 30b. Because detected edges 90a, 90b within the ROI 70b are found substantially parallel to the exposed edge 16, the parking space B1 is detected as occupied. As they correspond to parts of a vehicle (e.g. the bottom edge of the body, the bottom edge of the side window), these detected edges 90a, 90b are referred to as the signature edges of the detected vehicle 30b.

In general, the background-subtraction algorithm is computationally efficient, but not robust. It is sensitive to occlusion, shadow, lighting variations or surface conditions. For example, the morning sun and the noon sun may cast different shadows; a sunny day and a cloudy (i.e. no sun) day may create different lighting; a wet, snowy or leafy surface may alter the background image. On the other hand, the edge-detection algorithm is robust, but computationally inefficient. The prior arts cannot meet the efficiency and robustness requirements for parking detection.

### OBJECTS AND ADVANTAGES

It is a principle object of the present invention to conserve energy resources and enhance the quality of the environment.

It is a further object of the present invention to provide a parking-detection method with both efficiency and robustness.

It is a further object of the present invention to provide a parking-detection method with computational efficiency.

It is a further object of the present invention to provide a parking-detection method insensitive to viewing angle, shadow, lighting variations and surface conditions.

In accordance with these and other objects of the present invention, the present invention discloses hybrid parking-detection device and method.

### SUMMARY OF THE INVENTION

The present invention discloses a hybrid parking-detection device. It comprises an optical detector, a memory and a processor. The optical detector includes at least a camera. It captures the images of a parking area including a plurality of parking spaces. The memory stores at least a parking-detection algorithm and a background database. The parking-detection algorithm includes at least a background-subtraction algorithm and an edge-detection algorithm. The background database includes a plurality of background images for each parking space. These background images include the background images for different times/days and under varying lighting/surface conditions. For example, the background database includes the background images for each parking space at every daytime hour for every week and under the sun/dry, no-sun/dry, sun/wet, no-sun/wet conditions. Building such a large background database can eliminate as much as possible the effects of shadow, lighting and surface variations on the background-subtraction algorithm.

The hybrid parking-detection method combines the strengths of the background-subtraction algorithm and the edge-detection algorithm. The processor is configured to select either the background-subtraction algorithm or the edge-detection algorithm based on a set of pre-determined conditions. For example, being computationally efficient, the background-subtraction algorithm is used whenever possible. On the other hand, being robust, the edge-detection algorithm is used at calibration points, or when the background-subtraction algorithm cannot reliably determine the parking state. The present invention discloses three preferred hybrid parking-detection methods.

The first preferred method directly detects the state of a parking space. The background-subtraction algorithm is used if a proper background image is available from the background database; otherwise, the edge-detection algorithm is used. The proper background image is the background image around the current time/day and under similar lighting/surface conditions. If the edge-detection algorithm detects a vacant parking space, the current image will be output to the background database as a current (i.e. for the current time/day and under the current lighting/surface conditions) background image for the parking space.

The second preferred method detects the state change of a parking space. The current image is compared with a previous image. In the case of an initial vacant state, if there is a substantial change, the state of the parking space becomes occupied; otherwise, there is no state change and the current image will be output to the background database to update the current background image. In the case of an initial occupied state, for a substantial image change, the background-subtraction algorithm is used if a proper background image is available; otherwise, the edge-detection algorithm is used. Similarly, if the edge-detection algorithm detects a vacant parking space, the current image will be output to the background database as a current background image for the parking space.

The third preferred method improves the robustness of the background-subtraction algorithm by embedding the edge-detection algorithm into the background-subtraction algorithm. If the difference (D) between a current image and a proper background image is below a first threshold (D<C₁), the state of the parking space is vacant; if the difference is above a second threshold (D>C₂), the state of the parking space is occupied; if the difference is between the first and second thresholds (C₁<D<C₂), an edge-detection algorithm is used to further differentiate the parking state.

### BRIEF DESCRIPTION OF THE DRAWINGS

FIG. 1A is a side view of a street with a vacant parking space B1; FIG. 1B is the same side view of the street with an occupied parking space B1; FIGS. 1A-1B further show the ROI 60b for the parking space B1 used by the background-subtraction algorithm;

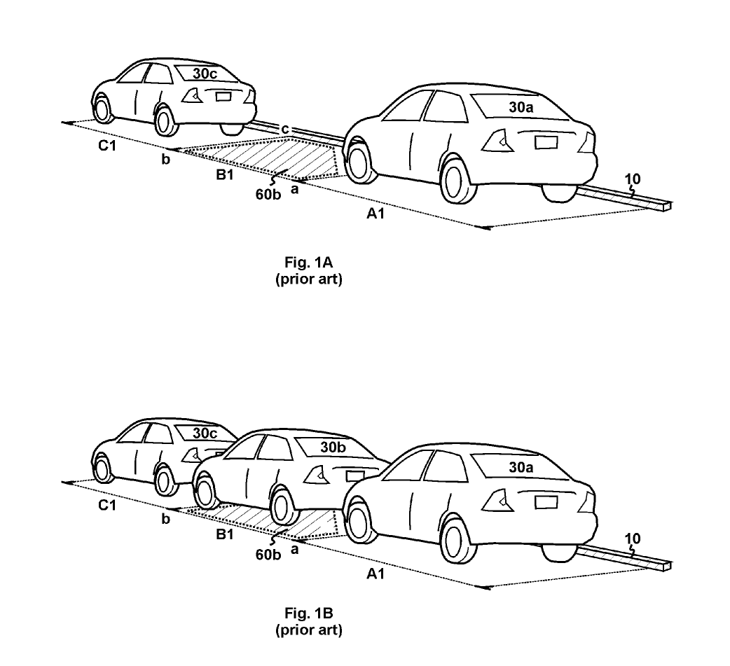

FIG. 2A is a side view of a street with a vacant parking space B1; FIG. 2B is the same side view of the street with an occupied parking space B1; FIGS. 2A-2B further show the ROI 70b for the parking space B1 used by the edge-detection algorithm;

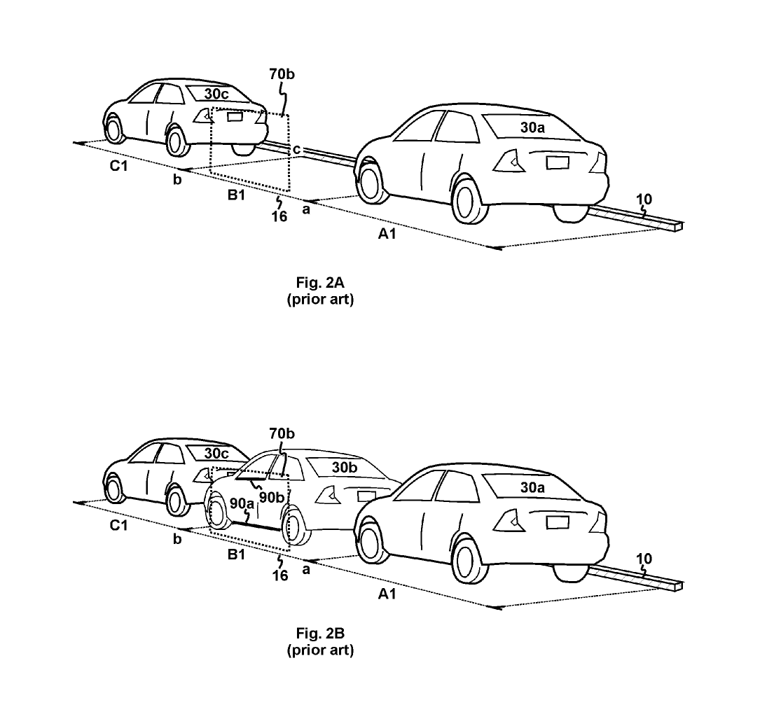

FIG. 3 is a block diagram of a preferred hybrid parking-detection device;

FIG. 4 is a block diagram of a preferred parking-detection algorithm;

FIGS. 5A-5B are block diagram of a preferred background database;

FIG. 6 illustrates the steps of a first preferred hybrid parking-detection method;

FIGS. 7A-7BB illustrate the steps of a second preferred hybrid parking-detection method;

FIG. 8 illustrates the steps of a third preferred hybrid parking-detection method.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

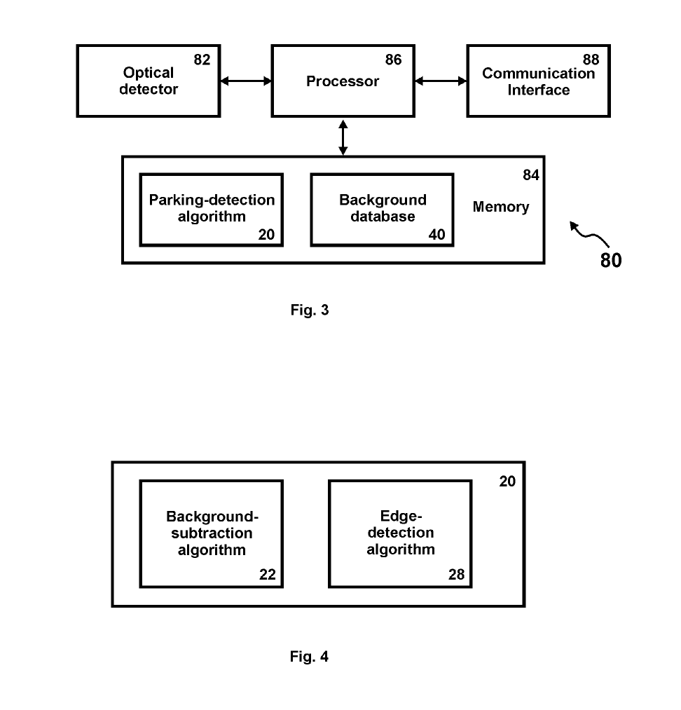

Referring now to FIG. 3, a preferred hybrid parking-detection device 80 is shown. It comprises an optical detector 82, a memory 84, a processor 86 and a communication interface 88. The optical detector 82 includes at least a camera. It captures the images of a parking area including a plurality of parking spaces (e.g. A1, B1). The memory 84 stores at least a parking-detection algorithm 20 and a background database 40. Typical memory is a flash memory. The processor 86 runs the parking-detection algorithm 20, processes the images captured by the optical detector 82 and generates the parking state data. The communication interface 88 transfers the parking state data to a parking server at a pre-determined interval (e.g. once every ten seconds). It may also receive information such as time, date, lighting and surface conditions from a third party. The communication interface 88 preferably comprises a wireless communication interface, e.g. a WiFi/cellular communication interface.

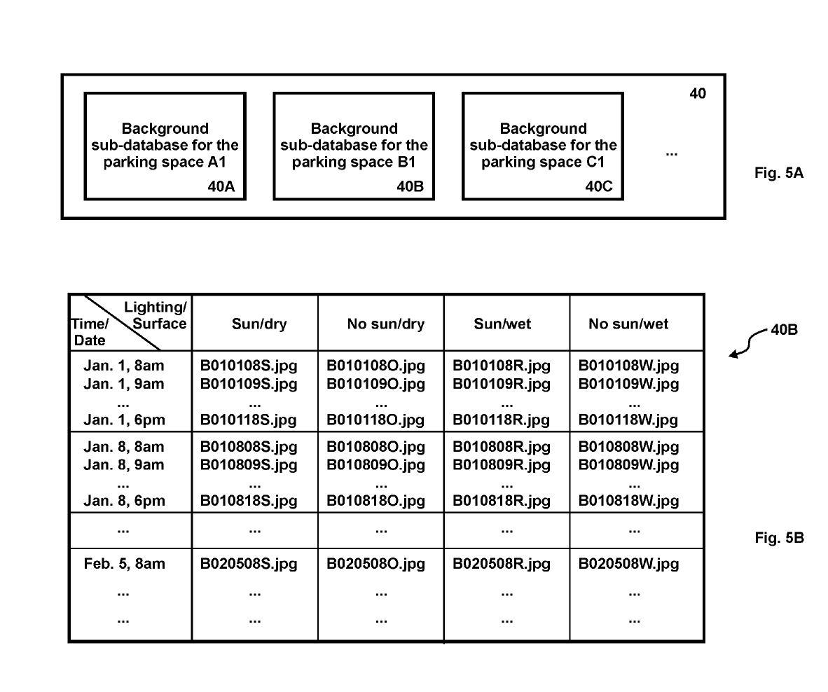

Referring now to FIG. 4, a preferred parking-detection algorithm 20 is disclosed. It includes at least a background-subtraction algorithm 22 and an edge-detection algorithm 28. For the background-subtraction algorithm 22, a parking space is occupied if its current image is substantially different from its background image. For the edge-detection algorithm 28, a parking space is occupied if at least a detected edge is parallel to the exposed edge of the parking space.

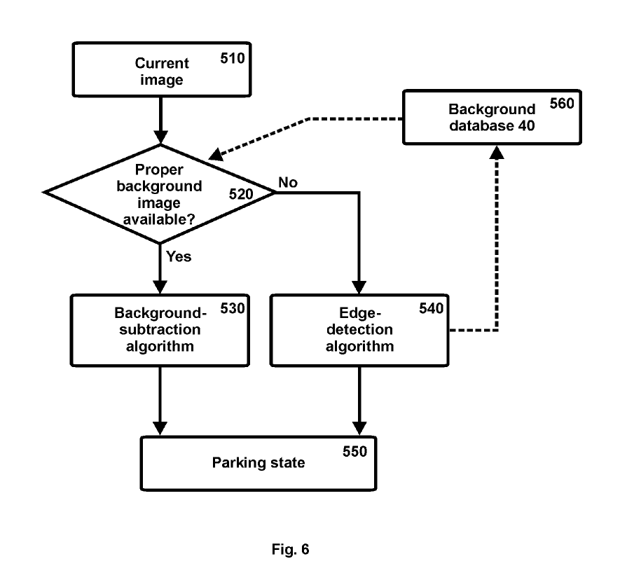

Referring now to FIGS. 5A-5B, a background database 40 is shown. It comprises a plurality of sub-databases 40A-40C (FIG. 5A). Each sub-database (e.g. 40B) includes a plurality of background images for each parking space (e.g. B1). They include the background images for different times/days and under varying lighting/surface conditions. For example, the background sub-database includes the background images at every daytime hour (e.g. 8 am, 9 am . . . ) for every week (e.g. the week of Jan. 1, the week of Jan. 8, . . . ) under the sun/dry, no-sun/dry, sun/wet, no-sun/wet conditions (FIG. 5B). Apparently, other times/day and lighting/surface combinations can be included in the background sub-database. Building such a large background database can eliminate as much as possible the effects of shadow, lighting and surface variations on the background-subtraction algorithm.

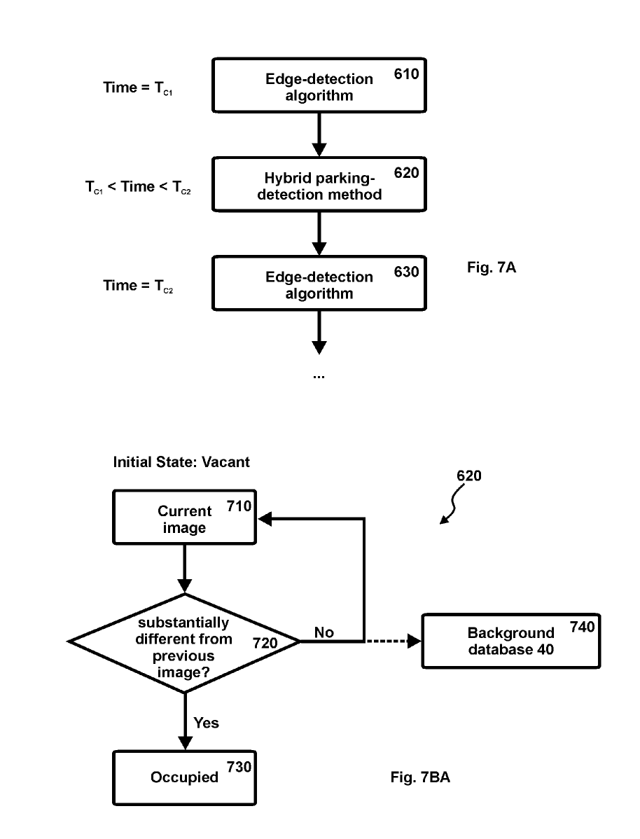

The hybrid parking-detection method of the present invention combines the strengths of the background-subtraction algorithms and the edge-detection algorithm. The processor is configured to select either the background-subtraction algorithm or the edge-detection algorithm based on a set of pre-determined conditions. For example, being computationally efficient, the background-subtraction algorithm is used whenever possible. On the other hand, being robust, the edge-detection algorithm is used at calibration points, or when the background-subtraction algorithm cannot reliably determine the parking state. The present invention discloses three preferred hybrid parking-detection methods. They are illustrated in FIGS. 6-8.

FIG. 6 illustrates the steps of a first preferred hybrid parking-detection method. It directly detects the state of a parking space and includes the following steps. First, the current image of a parking space (within its ROI) is cropped from the captured image (step 510). Then a proper background image for this parking space is searched in the background database 40. If it is available (step 520), the background-subtraction algorithm is used (step 530) to obtain the parking state (step 550); otherwise, the edge-detection algorithm is used (step 540) to obtain the parking state (step 550). If the edge-detection algorithm detects a vacant parking space, the current image will be output to the background database 40 as a current (i.e. for the current time/day and under the current lighting/surface conditions) background image for the parking space (step 560).

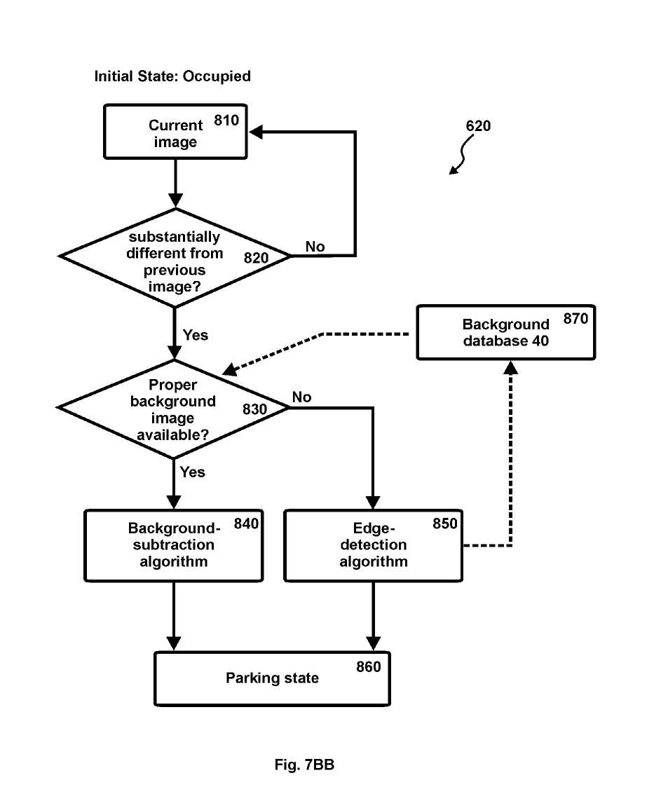

FIGS. 7A-7BB illustrate the steps of a second preferred hybrid parking-detection method, which detects the state change of a parking space. FIG. 7A shows the overall steps involved in this preferred parking-detection method. At a plurality of calibration points T_{C1} (e.g. 8 am of each day), T_{C2} (e.g. 12 pm of each day) . . . , the edge-detection algorithm is used to calibrate the parking state (steps 610, 630). These calibration steps take advantage of the robustness of the edge-detection algorithm. Between the calibration points, a hybrid parking-detection method (e.g. 620) is used. FIGS. 7BA-7BB discloses more details on the hybrid parking-detection method.

For FIG. 7BA, the initial state of the parking space is vacant. The hybrid parking-detection method 620 first compares the current image with a previous image (step 710). The previous image is an image captured before the most recent image, preferably an image captured immediately before the most recent image. Considering the time interval between successive image captures is small (e.g. around ten seconds), if there is a substantial change (step 720), the parking space becomes occupied (step 730). Otherwise, the parking space remains vacant and the device 80 waits to capture another image. In the meantime, the current image will be output to the background database 40 to update the current background image for the parking space (step 740).

For FIG. 7BB, the initial state of the parking space is occupied. The hybrid parking-detection method 620 first compares the current image with a previous image (step 810). For a substantial change (step 820), the background-subtraction algorithm is used (step 840) to detect the parking state (step 860) if a proper background image is available (step 830). Otherwise, the edge-detection algorithm is used (step 850) to detect the parking state (step 860). Similarly, if the edge-detection algorithm detects a vacant parking space, the current image will be output to the background database 40 as an updated background image for the parking space (step 870).

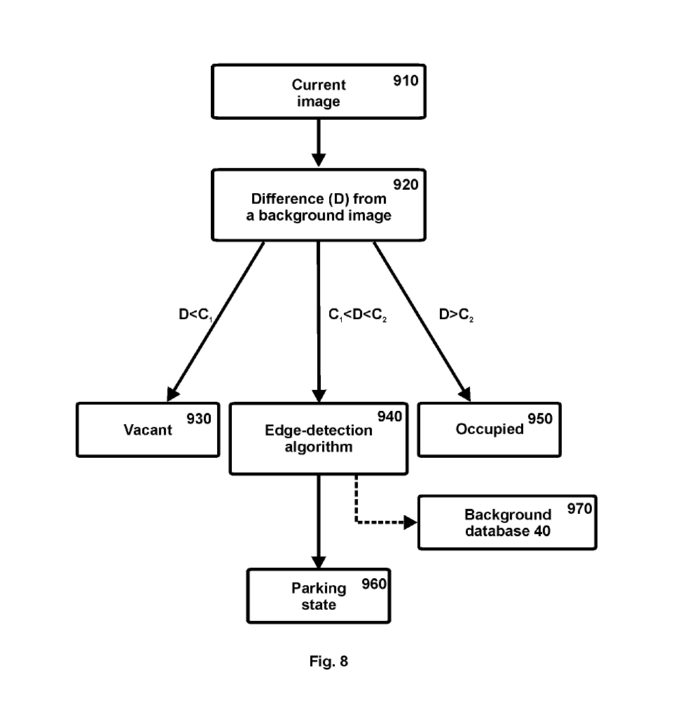

FIG. 8 illustrates the steps of a third preferred hybrid parking-detection method. This method enhances the robustness of the background-subtraction algorithm by embedding the edge-detection algorithm into the background-subtraction algorithm. If the difference (D) (step 920) between a current image (step 910) and a proper background image is below a first threshold (D<C₁), the state of the parking space is vacant (step 930); if the difference is above a second threshold (D>C₂), the state of the parking space is occupied (step 950); if the difference is between the first and second thresholds (C₁<D<C₂), the edge-detection algorithm is used (step 940) to further differentiate the parking state (step 960). Similarly, if the edge-detection algorithm detects a vacant parking space, the current image will be output to the background database 40 as a current background image for the parking space (step 970). Besides enhancing the background-subtraction algorithm (FIG. 6), this method can be easily extended to the parking-detection method (i.e. comparing the current image with a previous image) disclosed in FIGS. 7BA-7BB.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

What is claimed is:

1. A hybrid parking-detection device, comprising:
an optical detector for capturing a image of a parking area, said parking area including a plurality of parking spaces;
a memory for storing at least a background-subtraction algorithm and an edge-detection algorithm;
a processor for detecting parked vehicles in said parking area, wherein said processor is configured to select said background-subtraction algorithm under a first condition and select said edge-detection algorithm under a second condition.

2. The device according to claim 1, wherein said first condition is that said memory stores a proper background image for a selected one of said parking spaces.

3. The device according to claim 2, wherein said proper background image is a background image for said selected parking space around the current time/day and under similar lighting/surface conditions.

4. The device according to claim 2, wherein said processor compares the current image of said selected parking space with said proper background image.

5. The device according to claim 4, wherein said processor determines that said selected parking space is vacant and outputs the current image of said selected parking space to said memory as a current background image for said selected parking space.

6. The device according to claim 1, wherein said second condition is that said memory does not store a proper background image for a selected one of said parking spaces.

7. The device according to claim 1, wherein said second condition is that the difference between the current image and the background image for a selected one of said parking spaces is above a first threshold but below a second threshold.

8. The device according to claim 1, wherein said second condition is that the time is at a pre-determined calibration point.

9. The device according to claim 1, wherein said processor detects at least a signature edge of a vehicle from the current image of a selected one of said parking spaces under said second condition.

10. The device according to claim 9, wherein said processor determines that said selected parking space is vacant and outputs the current image of said selected parking space to said memory as a current background image for said selected parking space.

11. The device according to claim 1, wherein said memory stores a plurality of background images for different time/day and under varying lighting/surface conditions.

12. The device according to claim 1, wherein said background-subtraction algorithm uses a different region of interest (ROI) than said edge-detection algorithm.

13. A hybrid parking-detection device, comprising:
an optical detector for capturing an image of a parking area, said parking area including a plurality of parking spaces;
a memory for storing a plurality of background images for at least a selected one of said parking spaces;
a processor for detecting a parked vehicle in said selected parking space, wherein said processor compares the current image of said selected parking space with a proper background image selected from said plurality of background images for said selected parking space.

14. The device according to claim 13, wherein said plurality of background images include background images for different time/day and under varying lighting/surface conditions.

15. The device according to claim 13, wherein said proper background image is a background image for said selected parking space around the current time/day and under similar lighting/surface conditions.

16. The device according to claim 13, wherein said processor determines that said selected parking space is vacant and outputs the current image of said selected parking space to said memory as a current background image for said selected parking space.

17. The device according to claim 13, wherein said processor is configured to select an edge-detection algorithm when the difference between the current image and the background image for said selected parking space is above a first threshold but below a second threshold.

18. The device according to claim 17, wherein said processor determines that said selected parking space is vacant and outputs the current image of said selected parking space to said memory as a current background image for said selected parking space.

19. The device according to claim 13, wherein said processor is configured to select an edge-detection algorithm at a pre-determined calibration point.

20. The device according to claim 19, wherein said processor determines that said selected parking space is vacant and outputs the current image of said selected parking space to said memory as a current background image for said selected parking space.
